(19) United States
(12) Patent Application Publication
(10) Pub. No.: US 2025/0109797 A1
(43) Pub. Date: Apr. 3, 2025

(54) System having a gas seal and method for operating the system

(71) Applicant: Siemens Energy Global GmbH & Co. KG, München (DE)

(72) Inventors: Thorsten Kamp, Duisburg (DE); Detlef Konrad, Duisburg (DE)

(21) Appl. No.: 18/729,193

(22) PCT Filed: Dec. 21, 2022
(86) PCT No.: PCT/EP2022/087207

§ 371 Date: Jul. 16, 2024

(30) Foreign Application Priority Data
Jan. 20, 2022 (EP) 22152349.1

(51) Int. Cl. F16J 15/40

(52) U.S. Cl. CPC F16J 15/40

(57) ABSTRACT

The invention relates to a system and to a method for operating a system, wherein the system includes a turbo machine with a gas seal. The gas seal is supplied with a gas, in particular sealing gas, via a gas seal supply line, wherein use is made of an analysis unit which is designed to determine a physical value of the gas which flows into the gas seal.

### BACKGROUND

The invention relates to a system comprising a turbomachine with a gas seal, wherein the gas seal is fluidically connected to a gas seal supply line.

The invention furthermore relates to a method for operating a system, wherein the system comprises a turbomachine with a gas seal, wherein the gas seal is supplied with a gas, in particular a barrier gas, through a gas seal supply line.

Gas seals are the seals preferentially used for turbomachines, in particular compressors that are configured as turbomachines, at relatively high pressures due to the comparatively low leakage. In comparison with a conventional labyrinth seal, the leakage of a dry gas seal, which is an order of magnitude less, allows a significant increase in the efficiency of the corresponding turbomachine.

Compared with the comparatively simply constructed labyrinth seals, modern dry gas seals are comparatively demanding in terms of the operating conditions. Reliable operation requires a correspondingly conditioned and purified barrier gas. Furthermore, dry gas seals are dependent on a particular minimum rotational speed for reliable operation.

In the gas seals mentioned in the introduction, a rotating sealing ring and a stationary sealing ring generally face one another on a radially extending seal plane respectively with a sealing face on the sealing rings. So that the sealing principle can be implemented successfully, it is necessary for the sealing faces of the two sealing rings to be accurately processed and aligned with one another, so that a lubricating film of the seal gas is formed under reproducible operating conditions between the sealing faces and the seals can accordingly operate contactlessly. The high precision requirements are generally achieved under all conceivable operating conditions only with a particular selection of materials. The rotating and stationary sealing rings are therefore generally not connected integrally to the rotor or stator, respectively, the stationary sealing ring generally also being braced resiliently against the rotating sealing ring. The rotating sealing ring is fixed on the rotor so that uncontrolled relative movements do not occur, particularly in the axial direction. In conventional sealing arrangements, fretting often takes place at the axial contact between the rotating sealing ring and a corresponding axial contact support of the rotor, since conventional arrangements allow an axial relative movement.

### SUMMARY

The object of the invention is to provide a system and a method with which improved operation can be achieved.

In one embodiment, a system includes a turbomachine with a gas seal, wherein the gas seal is fluidically connected to a gas seal supply line, characterized by an analysis unit, which is configured to determine a physical value of a gas that flows into the gas seal, the analysis unit being configured to determine a molar mass of the gas, further comprising a regulating unit which regulates a valve in the gas seal supply line, the physical value determined in the analysis unit being taken into account for the regulating of the valve.

In another embodiment, method for operating a system having a turbomachine with a gas seal, the method includes suppling the gas seal with a gas, in particular a barrier gas, through a gas seal supply line, determining, by an analysis unit a physical value of the gas that flows into the gas seal, wherein the analysis unit is configured to determine a molar mass of the gas, and regulating, by a regulating unit, a valve in the gas seal supply line, wherein the physical value determined in the analysis unit is taken into account for the regulating of the valve.

In exemplary embodiments, the gas flowing into the gas seal is analyzed with an analysis unit. With this analysis unit, a physical value of the gas is determined. The quality of the gas is so to speak determined with this physical value.

With knowledge of the physical value, the operation of the system may be influenced. For this purpose, a regulating unit which receives the physical value as a parameter is used. The regulating unit is then used to control a valve that is arranged in the gas supply system.

Furthermore, a heating unit with which the gas can be heated may be used in the gas supply system. The heating unit is controlled by means of the regulating unit.

The above-described properties, features and advantages of this invention, as well as the way in which they are achieved, will become clearer and more easily understandable in conjunction with the following description of the exemplary embodiments, which will be explained in more detail in connection with the drawings.

### DETAILED DESCRIPTION

Identical components or components with the same function are denoted with the same reference signs.

Exemplary embodiments of the invention will be described below with the aid of the drawings. The latter are not intended to represent the exemplary embodiments true to scale, but rather the drawing is rendered in a schematized and/or slightly distorted form where this is useful for explanation. In respect of additions to the teachings immediately recognizable in the drawing, reference is made to the relevant prior art.

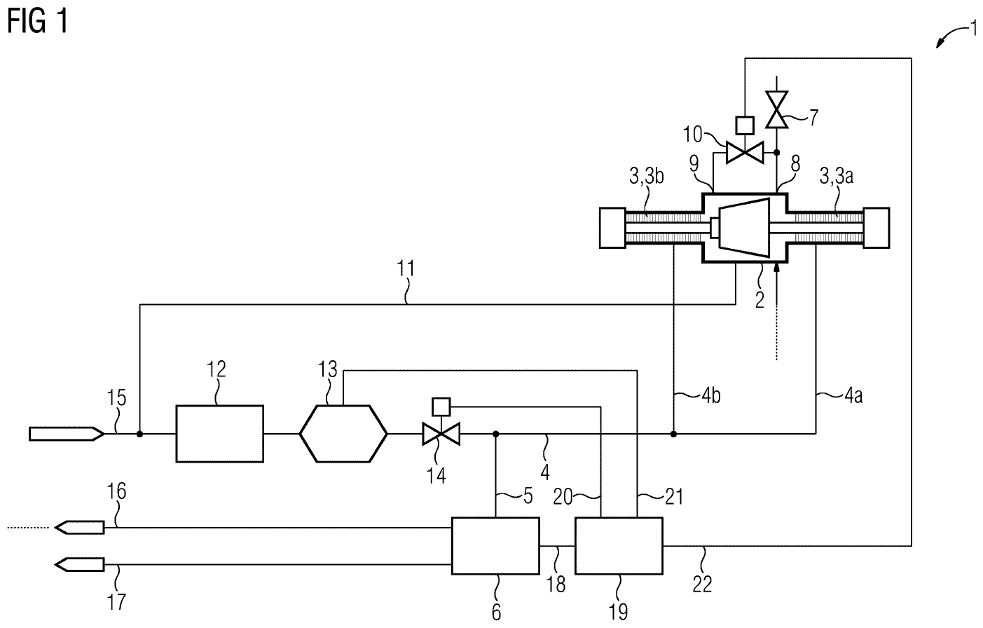

FIG. 1 shows a schematic representation of a system according to the invention

FIG. 1 shows a system 1. The system 1 comprises a turbomachine 2. The turbomachine 2 may be a compressor, a steam turbine, an expander, an expander operated with supercritical carbon dioxide, or a turbomachine, or the like.

The turbomachine 2 essentially has a rotatably mounted rotor and a housing arranged around the rotor. The turbomachine 2 furthermore has a gas seal 3, a gas seal 3a and 3b respectively being arranged at the ends of the turbomachine. The gas seal 3 is configured as a dry gas seal and is supplied with a gas, in particular a barrier gas.

The gas seal 3 is fluidically connected to a gas seal supply line 4. In the exemplary embodiment shown in FIG. 1, the gas seal supply line 4 branches into a first gas seal supply line 4a and a second gas seal supply line 4b, the first gas seal supply line 4a being fluidically connected to the gas seal 3a and the second gas seal supply line 4b being fluidically connected to the second gas seal.

A part of the gas is branched off through an analysis line 5 and delivered to an analysis unit 6. The analysis unit 6 is configured to determine a physical value of the gas that flows into the gas seal 3, 3a, 3b.

In the exemplary embodiment shown in FIG. 1, the molar mass is determined in the analysis unit 6.

Process gas flows into the turbomachine 1 through a process gas valve 7. This process gas flows into an inflow region 8 of the turbomachine 1. After the process gas has flowed through the turbomachine 1, the process gas flows out of the turbomachine 1 through an outflow region 9. The inflow region 8 is fluidically connected to the outflow region 9 by means of a connecting valve 10.

A part of the process gas is branched off through a process gas line 11 and delivered to a conditioning system 12. The conditioning system 12 is configured to condition the gas, an exit of the conditioning system 12 being fluidically connected to the gas seal supply line 4.

In the conditioning system, the gas is filtered, purified and/or dehydrated.

In the exemplary embodiment shown in FIG. 1, gas can be delivered into the gas seal supply line 4 through a supply line 15.

The gas flowing out of the analysis unit 6 through an outflow line 16 is delivered back to the turbomachine 1, this being symbolized in FIG. 1 by arrows and a dotted representation.

In an operating situation, it may be the case that a part of the gas flowing out of the analysis unit 6 flows out directly through a blow-off line 17 and is optionally burnt.

Downstream of the conditioning system 12, the gas flows through a heating unit 13, the heating unit 13 being configured to heat the gas. The heating unit 13 can be regulated by means of the regulating unit 19.

Downstream of the heating unit 13, the gas flows further through a valve 14 which is arranged in the gas seal supply line 4. Downstream of the valve 14, the gas flows through the gas seal supply line 4a and 4b respectively to the gas seal 3a and 3b.

The physical value determined in the analysis unit 6 is delivered via a first data line 18 to a regulating unit 19.

The regulating unit 19 is configured in such a way that the physical value, for example the molar mass, is used as a regulating parameter and the valve 14 is controlled via a first regulating line 20. The heating unit 13 is regulated via a second regulating line 21.

In a further alternative embodiment, a third regulating line 22 is connected in terms of regulating technology to the connecting valve 10, the connecting valve 10 being regulated by means of the regulating unit 19.

1. A system comprising:
a turbomachine with a gas seal, wherein the gas seal is fluidically connected to a gas seal supply line, characterized by an analysis unit, which is configured to determine a physical value of a gas that flows into the gas seal, the analysis unit being configured to determine a molar mass of the gas, further comprising a regulating unit which regulates a valve in the gas seal supply line, the physical value determined in the analysis unit being taken into account for the regulating of the valve.

2. The system as claimed in claim 1, wherein the turbomachine is configured as a compressor, the compressor being configured to compress a process gas.

3. The system as claimed in claim 1, further comprising a process gas line which is fluidically connected to the turbomachine, the process gas line being configured in such a way that a part of the process gas can flow through the process gas line, wherein a conditioning system, which is configured to condition the gas, is arranged in the process gas line, and wherein an exit of the conditioning system is fluidically connected to the gas seal supply line.

4. The system as claimed in claim 3, wherein the gas is filtered, purified and/or dehydrated in the conditioning system.

5. The system as claimed in claim 1, further comprising a heating unit for heating the gas is formed in the gas seal supply line, the heating unit being regulatable by means of the regulating unit.

6. The system as claimed in claim 1, wherein the turbomachine is coupled in terms of regulating technology to the regulating unit.

7. A method for operating a system having a turbomachine with a gas seal, the method comprising:
suppling the gas seal with a gas, in particular a barrier gas, through a gas seal supply line;
determining, by an analysis unit a physical value of the gas that flows into the gas seal, wherein the analysis unit is configured to determine a molar mass of the gas; and
regulating, by a regulating unit, a valve in the gas seal supply line, wherein the physical value determined in the analysis unit is taken into account for the regulating of the valve.

8. The method as claimed in claim 7, wherein a process gas flows through the turbomachine, a part of the process gas being diverted out of the turbomachine and flowing through a conditioning system, the process gas being filtered, purified and/or dehydrated in the conditioning system.

9. The method as claimed in claim 8, wherein the gas flowing out downstream of the conditioning system is delivered back to the gas seal, a part of the gas being fed to the analysis unit.

10. The method as claimed in claim 7, wherein the regulating unit regulates a valve which is arranged in the gas seal supply line.

11. The method as claimed in claim 7, wherein a temperature of the gas is modified with a heating unit, the heating unit being regulated by means of the regulating unit.

12. The method as claimed in claim 8, wherein the regulating unit regulates a flow rate of the process gas through the turbomachine.

13. The method as claimed in claim 7, wherein the turbomachine is configured as a compressor.
